(19) United States
(12) Patent Application Publication
(10) Pub. No.: US 2022/0243793 A1
(43) Pub. Date: Aug. 4, 2022

(54) SELF-LOCKING APPARATUS FOR LINEAR ACTUATOR, AND LINEAR ACTUATOR

(71) Applicant: ZHEJIANG JIECANG LINEAR MOTION TECHNOLOGY CO., LTD., Zhejiang (CN)

(72) Inventors: Renchang HU, Zhejiang (CN); Xiaojian LU, Zhejiang (CN); Donghai WU, Zhejiang (CN); Yunshan CHENG, Zhejiang (CN)

(73) Assignee: ZHEJIANG JIECANG LINEAR MOTION TECHNOLOGY CO., LTD., Zhejiang (CN)

(21) Appl. No.: 17/630,533

(22) PCT Filed: Aug. 17, 2020
(86) PCT No.: PCT/CN2020/109658

§ 371 Date: Jan. 27, 2022

(30) Foreign Application Priority Data
Sep. 12, 2019 (CN) 201910864861.7

(51) Int. Cl. F16H 25/24; F16D 63/00

(52) U.S. Cl. CPC F16H 25/2454; A47B 9/20; F16D 63/008

(57) ABSTRACT

Disclosed is a self-locking apparatus for a linear actuator, which relates to the field of linear actuation equipment. The self-locking apparatus includes a one-way bearing and a friction collar, wherein the one-way bearing includes an inner race and an outer race, the inner race being sleeved to the rotary screw of the linear actuator, the friction collar being connected to the outer race; wherein the self-locking apparatus further includes a friction member fitted with the friction collar, such that when the rotary screw rotates forwardly, the outer race does not rotate; and when the rotary screw rotates reversely, the outer race, the inner race, and the friction collar rotate synchronously, such that friction is produced by contacting between the friction collar and the friction member. Further disclosed is a linear actuator applying the self-locking apparatus.

### TECHNICAL FIELD

Embodiments of the present disclosure relate to the field of linear actuation equipment, and more particularly relate to a self-locking apparatus for a linear actuator, and a linear actuator.

### BACKGROUND

Linear actuators are currently applied in a wide array of fields, including electric height adjustable tables/desks, electric beds, and electric sofa, etc. Such linear actuators generally have a structure comprising a driving motor, a rotary screw, and a transmission nut, wherein the driving motor activates the rotary screw to rotate, and the rotating rotary screw drives the transmission nut to move axially, wherein the transmission nut may be connected to an object to actuate, thereby enabling actuation.

For example, a conventional electric height adjustable table comprises a lifting column, wherein the driving motor, the rotary screw, and the transmission nut are provided in the lifting column. Lifting and lowering of tubes are actuated by the transmission nut. Such electric height adjustable tables need a self-locking function, i.e., when the motor does not operate, the lifting column is self-lockable so as to prevent autonomous descending of the height adjustable table. The self-locking function of conventional lifting columns is mostly implemented using a brake torsion spring, wherein the rotary screw rotates reversely to cause the brake torsion spring gripped to produce a brake force. However, the self-locking force produced by conventional self-locking structures is not enough.

### SUMMARY

To overcome the above and other drawbacks in the present disclosure, embodiments of the present disclosure provide a self-locking apparatus for a linear actuator, and a linear actuator, which may enhance self-locking property of the linear actuator.

Embodiments of the present disclosure provide:

a self-locking apparatus for a linear actuator, comprising: a one-way bearing and a friction collar, wherein the one-way bearing comprises an inner race and an outer race, the inner race being sleeved to the rotary screw of the linear actuator, the friction collar being connected to the outer race; wherein the self-locking apparatus further comprises a friction member fitted with the friction collar, such that when the rotary screw rotates forwardly, the outer race does not rotate; and when the rotary screw rotates reversely, the outer race, the inner race, and the friction collar rotate synchronously, such that friction is produced by contacting between the friction collar and the friction member.

The present disclosure offers the following beneficial effects:

In the present disclosure, the self-locking apparatus employs a structure of fitting between the one-way bearing and the friction collar; since the one-way bearing can only rotate in one way, the inner race and the outer race in the one-way bearing are mutually separated when the rotary screw is rotating forward; in this case, the one-way bearing is like a typical roller bearing, i.e., rotation of the inner race does not bring the outer race to rotate. Under this status, the friction collar on the outer race does not move relative to the friction member, such that no friction is produced and the rotary screw may operate without resistance.

However, when the rotary screw rotates reversely, self-locking occurs between the inner race and the outer race of the one-way bearing, causing the inner race and the outer race to rotate synchronously; rotation of the outer race brings simultaneous rotation of the friction collar, while rotation of the friction collar incurs a relative movement with respect to the friction member. The relative movement between the friction collar and the friction member produces friction. Due to the principle of opposite action, the friction causes resistance against the rotary screw, equivalent to producing a self-locking force for the rotary screw.

Based on this structure, when the driving motor activates the rotary screw to rotate, a torsion of the driving motor suffices to overcome the self-locking force to cause the rotary screw to rotate reversely; therefore, with the driving motor as active drive, the self-locking apparatus does not affect normal extension or retraction of the linear actuator; however, when the driving motor does not operate and the rotary screw autonomously rotates reversely, the rotary screw has a motion tendency of reverse rotation. This motion tendency further causes a relative motion tendency between the friction collar and the friction member; however, the fiction between the friction collar and the friction member holds back the motion tendency, thereby implementing self-locking.

Moreover, compared with conventional flexible self-locking manner using a torsion spring, the self-locking apparatus according to the present disclosure relies on rigid self-locking using the friction collar and the friction member, rendering a more stable, greater self-locking force, which also ensures service life of the self-locking apparatus.

In an embodiment, a floating gap is provided between the friction collar and the friction member along an axial direction of the rotary screw.

In an embodiment, friction is produced between a circumferential side portion of the friction collar and the friction member; and/or, friction is produced between an axial end portion of the friction collar and the friction member.

Embodiments of the present disclosure further provide a linear actuator, comprising: a first sleeve, a second sleeve, a rotary screw, a transmission nut, and a driving motor, the driving motor activating the rotary screw to rotate, the rotating rotary screw driving the transmission nut to move axially, and movement of the transmission nut causing the first sleeve and the second sleeve to extend and retract relative to each other, wherein the self-locking apparatus according to any one of the above solutions is mounted on the rotary screw.

In an embodiment, the friction collar is sleeved over an outer race, and a plane bearing is further mounted on the transmission nut, the plane bearing and the friction member being located at two different axial sides of the friction collar.

In an embodiment, the linear actuator further comprises a support base, an axial direction of the support base being distant from the plane bearing; the friction member comprises a friction outer race mounted in the support base, the friction outer race being sleeved outside the friction collar, such that friction is produced by contacting between the friction outer race and a circumferential side portion of the friction collar.

In an embodiment, a circumferential sidewall of the friction collar has an outer conical surface, the conical surface being gradually shrunk towards a side distant from the plane bearing; an inner sidewall of the friction outer race has an inner conical surface adapted to the outer conical surface; or, a circumferential side surface of the friction collar is a stepped surface, the inner sidewall of the friction outer race being adapted to the stepped surface.

In an embodiment, the linear actuator further comprises a support base, an axial direction of the support base being distant from the plane bearing; and the friction member comprises a friction pad mounted in the support base, such that friction is produced when the friction pad abuts against an axial end portion of the friction collar.

In an embodiment, a stepped portion is provided on the rotary screw, wherein the plane bearing is axially positioned on the stepped portion.

In an embodiment, the support base is provided with a base cavity, wherein the friction member is mounted in the base cavity and the friction collar is at least partially embedded in the base cavity; and a radial support member is provided between the friction collar and a wall of the base cavity, the radial support member referring to a bearing or a support ring.

These characteristics and advantages of the present disclosure will be disclosed in detail in the preferred embodiments below with reference to the accompanying drawings.

### BRIEF DESCRIPTION OF THE DRAWINGS

Hereinafter, the present disclosure will be described in further detail with reference to the accompanying drawings:

FIG. 1 is an overall structural schematic diagram of a linear actuator in a first embodiment of the present disclosure;

FIG. 2 is an exploded schematic diagram of the linear actuator in the first embodiment of the present disclosure;

FIG. 3 is an enlarged view of part A in FIG. 2;

FIG. 4 is a sectional schematic diagram of a linear actuator in a first embodiment of the present disclosure;

FIG. 5 is an enlarged view of part B in FIG. 4;

FIG. 6 is an exploded schematic diagram of a self-locking apparatus in a second embodiment of the present disclosure;

FIG. 7 is a sectional schematic diagram of a self-locking apparatus in the second embodiment of the present disclosure.

### DETAILED DESCRIPTION

Hereinafter, the technical solutions of the present disclosure will be explained and illustrated through embodiments with reference to the accompanying drawings. However, the embodiments are only some embodiments of the present disclosure, not all of them. Other embodiments obtained by those skilled in the art without exercise of inventive work based on the examples in the embodiments all fall within the protection scope of the present disclosure.

In the description below, the orientation or position relationships indicated by the terms “inner,” “outer,” “upper,” “lower,” “left,” and “right,” etc. are intended only for facilitating description of the present disclosure and simplifying the illustrations, not for indicating or implying that the devices or elements have to possess those specific orientations or have to be configured and operated with those specific orientations; therefore, they should not be construed as limitations to the present disclosure.

### First Embodiment

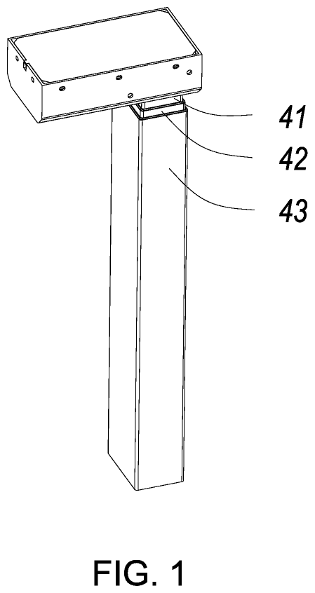

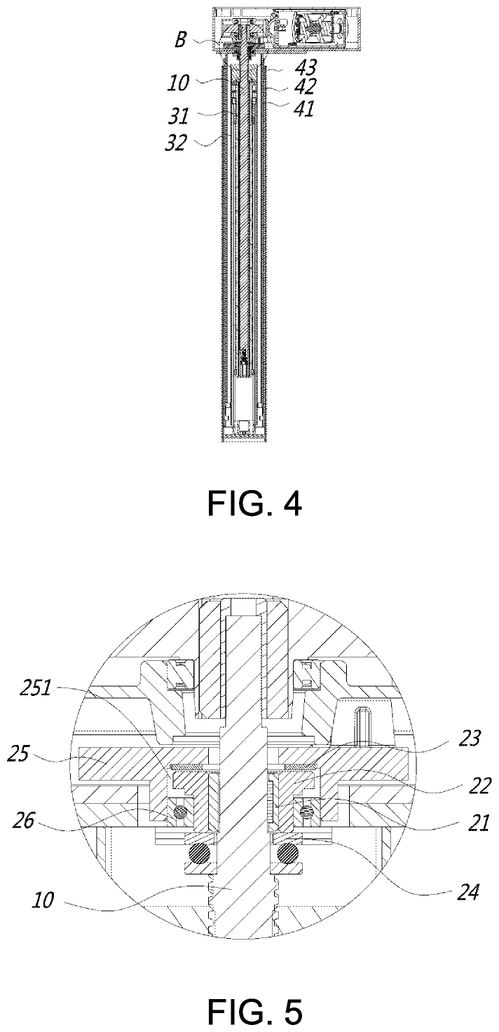

FIGS. 1 to 5 illustrate application of a self-locking apparatus to a linear actuator. Linear actuators come in various types, e.g., lifting column, electric pushrod, etc. In this embodiment, the self-locking apparatus is specifically applied to a lifting column. The lifting column, which is usually applied to an electric height adjustable table, is also referred to as a lifting leg. The lifting column may be lifted and lowered under actuation by a driving motor 11, thereby realizing lifting and lowering of a table top. For such electric height adjustable tables, their lifting and lowering are normally driven by the driver motor 11; however, once the driver motor 11 does not operator or is accidentally out of power, the lifting column per se needs a self-locking capability so as to prevent the table top from autonomously lowering under a relatively large load. Therefore, the lifting columns of conventional electric height adjustable tables are generally equipped with a self-locking apparatus. However, conventional self-locking apparatuses for lifting columns usually perform braking via a torsion spring.

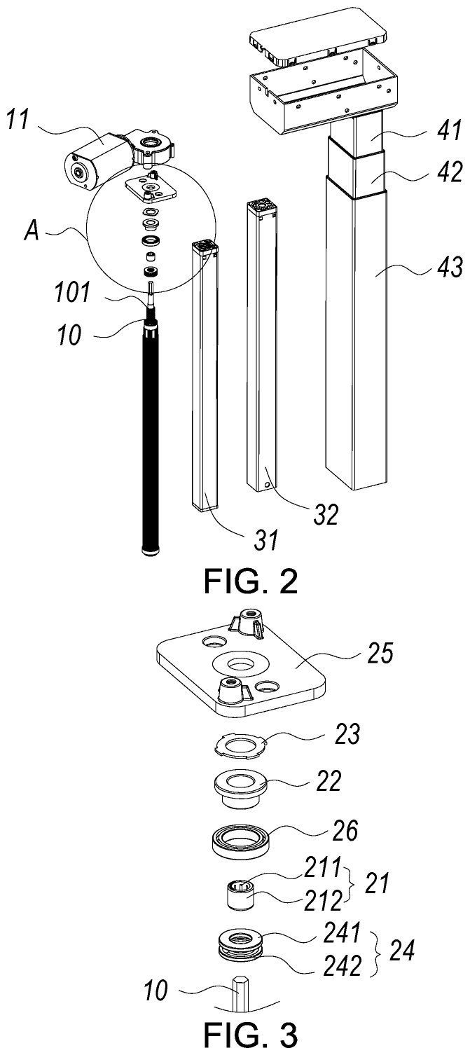

In this embodiment, as illustrated in FIGS. 2 and 3, a self-locking apparatus comprises a one-way bearing 21 and a friction collar 22, wherein the one-way bearing 21 comprises an inner race 211 and an outer race 212. Since the one-way bearing 21 is a common product in the mechanical field, it will not be described in detail herein. The inner race 211 of the one-way bearing 21 is sleeved to a rotary screw 10 of the linear actuator, the friction collar 22 is connected to the outer race 212. The self-locking apparatus further comprises a friction member 23 fitted with the friction collar 22, such that when the rotary screw 10 rotates forwardly, the outer race 212 does not rotate; and when the rotary screw 10 rotates reversely, the outer race 212, the inner race 211, and the friction collar 22 rotate synchronously, such that friction is produced by contacting between the friction collar 22 and the friction member 23.

In this embodiment, the self-locking apparatus employs a structure of fitting between the one-way bearing 21 and the friction collar 22; since the one-way bearing 21 can only rotate in one way, the inner race 211 and the outer race 212 in the one-way bearing 21 are mutually separated when the rotary screw 10 is rotating forward; in this case, the one-way bearing 21 is like a typical roller bearing, i.e., rotation of the inner race 211 does not bring the outer race 212 to rotate. Under this status, the friction collar 22 on the outer race 212 does not move relative to the friction member 23, such that no friction is produced and the rotary screw 10 may operate without resistance.

However, when the rotary screw 10 rotates reversely, self-locking occurs between the inner race 211 and the outer race 212 on the one-way bearing, causing the inner race 211 and the outer race 212 to rotate synchronously; rotation of the outer race 212 brings simultaneous rotation of the friction collar 22, while rotation of the friction collar 22 incurs a relative movement with respect to the friction member 23. The relative movement between the friction collar 22 and the friction member 23 produces friction. Due to the principle of opposite action, the friction causes resistance against the rotary screw 10, equivalent to generating a self-locking force for the rotary screw 10.

Based on this structure, when the driving motor 11 activates the rotary screw 10 to rotate, the torsion of the driving motor 11 suffices to overcome the self-locking force to cause the rotary screw 10 to rotate reversely; therefore, with the driving motor 11 as active drive, the self-locking apparatus does not affect normal extension or retraction of the linear actuator; however, when the driving motor 11 does not operate and the rotary screw 10 autonomously rotates reversely, the rotary screw 10 has a motion tendency of reverse rotation. This motion tendency further causes a relative motion tendency between the friction collar 22 and the friction member 23; however, the fiction between the friction collar and the friction member holds back the motion tendency, thereby implementing self-locking. In a scenario of applying the self-locking apparatus to a lifting column, when the driving motor 11 drives normally, the lifting column may be lifted and lowered normally, while when the driving motor does not work, thanks to the self-locking force of the self-locking apparatus, the load on the electric height adjustable table does not suffice to drive the lifting column to be lowered.

Moreover, compared with conventional flexible self-locking manner using a torsion spring, the self-locking apparatus according to the present disclosure relies on rigid self-locking using the friction collar 22 and friction member 23, rendering a more stable, greater self-locking force, which also ensures service life of the self-locking apparatus.

To reduce resistance applied by the self-locking apparatus to the rotary screw 10 when the driving motor 11 serves as active drive, a floating gap is provided between the friction collar 22 and the friction member 23 along an axial direction of the rotary screw 10. The axial direction herein refers to the axial direction of the rotary screw 10. Due to presence of the floating gap in the axial direction between the friction collar 22 and the friction member 23, the friction between the friction collar 22 and the friction member 23 is varied by an axial force. When the friction collar 22 and the friction member 23 are subjected to a relatively large axial stress, the floating gap between the friction collar 22 and the friction member 23 decreases, rendering a tighter contact and thus a larger friction; while when the friction collar 22 and the friction member 23 are subjected to a relatively small axial stress, the friction becomes smaller; in this way, the magnitude of the self-locking force may be autonomously controlled based on actual load on the height adjustable table. Specifically, FIG. 5 may be referenced. Since an axial motion interference usually arises when assembling the rotary screw 10, the rotary screw 10 has a slight axial play during the lifting and lowering of the height adjustable table; the axial play of the rotary screw 10 brings the friction collar 22 to approach to the friction member 23 axially or move away from the friction member 23 axially, thereby adjusting the floating gap between the friction collar 22 and the friction member 23.

The friction between the friction collar 22 and the friction member 23 may be implemented in various manners. In this embodiment, the friction is produced between the axial end portion of the friction collar 22 and the friction member 23. As illustrated in FIGS. 3-5, in this embodiment, the friction member 23 is a friction pad, wherein the friction collar 22 is sleeved over the rotary screw 10, and the friction pad is disposed above the friction collar 22, such that the top surface of the friction collar 22 contacts with the bottom surface of the friction pad to thereby produce friction.

In addition, a plane bearing 24 is preferably further provided in this embodiment. The plane bearing 24 is also sleeved over the rotary screw 10 and but sleeved beneath the axial direction of the friction collar 22. That is, the plane bearing 24 and the friction member 23 are disposed at two different axial sides of the friction collar 22. In this way, a smaller friction is produced when the rotary screw 10 rotates relative to the friction collar 22. That is, when the rotary screw 10 is driven by the driving motor 11 to rotate forwardly, the friction collar 22 and the upper race 241 of the plane bearing 24 maintains stationary, while the rotary screw 10 and the lower race 242 of the plane bearing 24 rotate together.

To facilitate assembly, a support base 25 is provided in this embodiment. The support base 25 is axially distant from the plane bearing 24, and the friction pad is installed in the support base 25. Additionally, a stepped portion 101 is provided on the rotary screw 10, and the plane bearing 24 is axially positioned on the stepped portion 101. In this way, the plane bearing 24, the friction collar 22, the one-way bearing 21, and the friction pad in this embodiment are all installed between the stepped portion 101 and the support base 25 to thereby perform axial positioning; when the rotary screw 10 is subjected to an axial force, the stepped portion 101 transmits the axial force to the plane bearing 24, which is then transmitted by the plane bearing 24 to the friction collar 22; finally, the friction collar 22 abuts against the friction pad to produce friction.

To offer a better stability to the self-locking apparatus, a base cavity 251 is provided for the support base 25, wherein the friction member 23 is installed in the base cavity 251 and the friction collar 22 is at least partially embedded in the base cavity 251. A radial support member 26 is provided between the friction collar 22 and a wall of the base cavity 251; wherein the radial support member 26 refers to a bearing or a support ring. In this embodiment, the radial support member 26 is preferably a bearing; in this way, the one-way bearing 21, the friction collar 22, the friction pad, and the support base 25 are substantially integrated, thereby achieving a better positioning effect either radially or axially, which offers a better stability.

### Second Embodiment

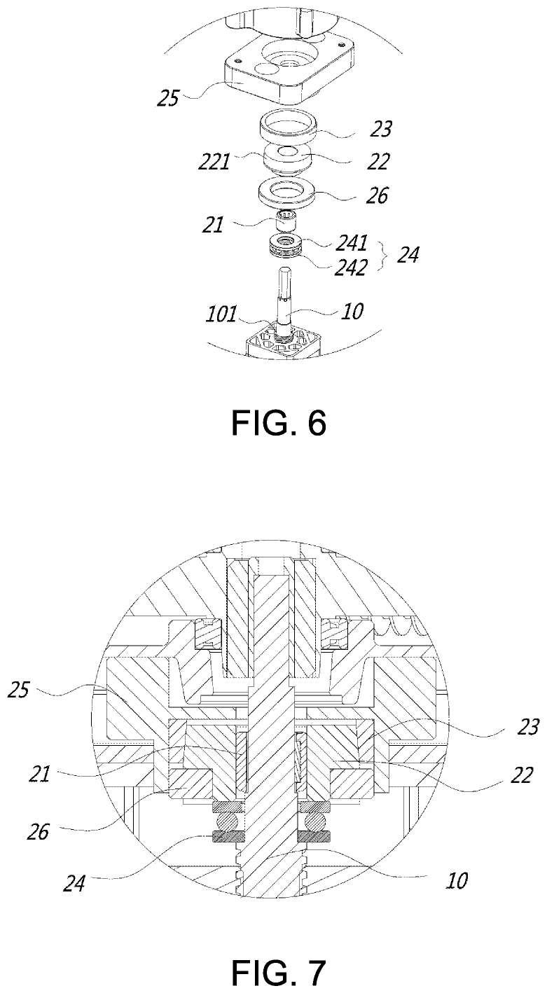

As illustrated in FIG. 6 and FIG. 7, the second embodiment differs from the first embodiment in that in the first embodiment, the friction between the friction member 23 and the friction collar 22 is produced by contacting between end portions; while in this embodiment, the friction between the friction member 23 and the friction collar 22 is produced by contacting between the circumferential side portion of the friction collar 22 and the friction member 23.

In this embodiment, the friction member 23 comprises a friction outer race installed in the support base 25. In this embodiment, since the support base 25 comprises a base cavity 251, the friction outer race may be installed by interference-fitting with the base cavity 251. Of course, in alternative embodiments, alternative fixed connection manners may also be adopted, wherein the friction outer race is sleeved outside the friction collar 22, such that the friction outer race contacts with the circumferential side portion of the friction collar 22 to produce friction.

The circumferential sidewall of the friction collar 22 preferably has an outer conical surface 221, the conical surface being gradually shrunk towards a side distant from the plane bearing; 24, and an inner sidewall of the friction outer race has an inner conical surface adapted the outer conical surface, as illustrated in FIG. 7. Like the first embodiment, the rotary screw 10 has an axial play space. The circumferential sidewall of the friction collar 22 is configured to have an outer conical surface 221, such that when the rotary screw 10 applies an axial force against the friction collar 22, the circumferential sidewall of the friction collar 22 is pressed increasingly tightly against the inner sidewall of the friction outer race, i.e., the greater the axial force, the greater the friction; the smaller the axial force, the smaller the friction. Or, the circumferential side surface of the friction collar is a stepped surface, the inner sidewall of the friction outer race being adapted to the stepped surface.

In addition, the radial support member 26 in this embodiment is preferably a support ring. The support ring may be a plastic collar, which is more cost-effective than bearings.

It is noted that the structure and shape of the circumferential sidewall of the friction collar 22 are not limited to the outer conical surface 221 in this embodiment. In alternative embodiments, its shape and structure may vary. For example, it may adopt a stepped surface, in which case, combination of the circumferential side friction and the end face friction is achieved. Likewise, other irregular shapes may also be employed. All of such embodiments fall within the protection scope of the present disclosure.

### Third Embodiment

As illustrated in FIGS. 1 to 5, this embodiment relates to a linear actuator. As described above, the linear actuator in this embodiment is preferably a lifting column, comprising: a first sleeve 31, a second sleeve 32, a rotary screw 10, a transmission nut, and a driving motor 11, wherein the driving motor 11 activates the rotary screw 10 to rotate, the rotating rotary screw 10 drives the transmission nut to move axially, and movement of the transmission nut drives the first sleeve 31 and the second sleeve 32 to extend and retract relative to each other.

The lifting column in this embodiment is preferably a three-segment lifting column, wherein the first sleeve 31, the second sleeve 32, the rotary screw 10, the transmission nut, and the driving motor 11 constitute a transmission assembly; the lifting column further comprises an inner tube 41, a middle tube 42, and an outer tube 43, wherein the transmission assembly drives the inner tube 41, the middle tube 42, and the outer tube 43 to extend and retract relative to each other. The operating principle of the three-segment lifting column has been disclosed in detail in previous applications filed by the same applicant, which will not be detailed here.

It is additionally noted that the linear actuator may refer to the lifting column as illustrated in this embodiment or an electric pushrod applied to an electric driving apparatus.

What have been described above are only embodiments of the present disclosure; however, the protection scope of the present disclosure is not limited thereto. A person skilled in the art should understand that the present disclosure includes, but not limited to the contents described in the drawings or the embodiments. Any modifications without departing from the functions and structural principles of the present disclosure will be included within the scope of the claims.

1. A self-locking apparatus for a linear actuator, comprising: a one-way bearing and a friction collar, wherein the one-way bearing comprises an inner race and an outer race, the inner race being sleeved to a rotary screw of the linear actuator, the friction collar being connected to the outer race; wherein the self-locking apparatus further comprises a friction member fitted with the friction collar, such that when the rotary screw rotates forwardly, the outer race does not rotate; and when the rotary screw rotates reversely, the outer race, the inner race, and the friction collar rotate synchronously, such that friction is produced by contacting between the friction collar and the friction member.

2. The self-locking apparatus according to claim 1, wherein a floating gap is provided between the friction collar and the friction member along an axial direction of the rotary screw.

3. The self-locking apparatus according to claim 1, wherein friction is produced between a circumferential side portion of the friction collar and the friction member; and/or, friction is produced between an axial end portion of the friction collar and the friction member.

4. A linear actuator, comprising: a first sleeve, a second sleeve, a rotary screw, a transmission nut, and a driving motor, the driving motor activating the rotary screw to rotate, the rotating rotary screw driving the transmission nut to move axially, and movement of the transmission nut causing the first sleeve and the second sleeve to extend and retract relative to each other; wherein the self-locking apparatus according to claim 1 is mounted on the rotary screw.

5. The linear actuator according to claim 4, wherein the friction collar is sleeved over an outer race, and a plane bearing is further mounted on the rotary screw, the plane bearing and the friction member being located at two different axial sides of the friction collar.

6. The linear actuator according to claim 5, wherein the linear actuator further comprises a support base, an axial direction of the support base being distant from the plane bearing; the friction member comprises a friction outer race mounted in the support base, the friction outer race being sleeved outside the friction collar, such that friction is produced by contacting between the friction outer race and a circumferential side portion of the friction collar.

7. The linear actuator according to claim 6, wherein a circumferential sidewall of the friction collar has an outer conical surface, the outer conical surface being gradually shrunk towards a side distant from the plane bearing; an inner sidewall of the friction outer race has an inner conical surface adapted to the outer conical surface; or, a circumferential side surface of the friction collar is a stepped surface, the inner sidewall of the friction outer race being adapted to the stepped surface.

8. The linear actuator according to claim 5, wherein the linear actuator further comprises a support base, an axial direction of the support base being distant from the plane bearing; and the friction member comprises a friction pad mounted in the support base, such that friction is produced when the friction pad abuts against an axial end portion of the friction collar.

9. The linear actuator according to claim 5, wherein a stepped portion is provided on the rotary screw, wherein the plane bearing is axially positioned on the stepped portion.

10. The linear actuator according to claim 6, wherein the support base is provided with a base cavity, the friction member is mounted in the base cavity and the friction collar is at least partially embedded in the base cavity, a radial support member is provided between the friction collar and a wall of the base cavity, and the radial support member is a bearing or a support ring.

11. A linear actuator, comprising: a first sleeve, a second sleeve, a rotary screw, a transmission nut, and a driving motor, the driving motor activating the rotary screw to rotate, the rotating rotary screw driving the transmission nut to move axially, and movement of the transmission nut causing the first sleeve and the second sleeve to extend and retract relative to each other; wherein the self-locking apparatus according to claim 2 is mounted on the rotary screw.

12. The linear actuator according to claim 8, wherein the support base is provided with a base cavity, the friction member is mounted in the base cavity and the friction collar is at least partially embedded in the base cavity, a radial support member is provided between the friction collar and a wall of the base cavity, and the radial support member is a bearing or a support ring.
